(19) United States
(12) Patent Application Publication
(10) Pub. No.: US 2009/0164761 A1
(43) Pub. Date: Jun. 25, 2009

(54) HIERARCHICAL SYSTEM AND METHOD FOR ANALYZING DATA STREAMS

(75) Inventors: George Bolt, Midhurst (GB); John Manslow, Southhampton (GB)

Correspondence Address: KNOBBE MARTENS OLSON & BEAR LLP, 2040 MAIN STREET, FOURTEENTH FLOOR, IRVINE, CA, 92614, US

(73) Assignee: Neural Technologies, Ltd., Petersfield (GB)

(21) Appl. No.: 12/340,504

(22) Filed: Dec. 19, 2008

Related U.S. Application Data
(63) Continuation of application No. 10/965,703, filed on Oct. 14, 2004.
Application No. 10/965,703 is a continuation of application No. PCT/AU03/00460, filed on Apr. 16, 2003.

(30) Foreign Application Priority Data
Apr. 16, 2002 (GB) 0208711.2

(51) Int. Cl. G06F 9/30

(52) U.S. Cl. 712/220; 712/E09.016

(57) ABSTRACT

A method for analyzing data streams comprises receiving a data stream, conducting a first analysis of the data stream for a possible target activity, and if a possible target activity is indicated generating a first alert. If the first alert is generated, a second analysis for the possible target activity is conducted to determine whether the target activity is indicated in the data stream with a high degree of certainty. If a possible target activity is indicated by the second analysis, a second alert is generated and provided to an external system for action.

### RELATED APPLICATIONS

This application is a continuation application, and claims the benefit under 35 U.S.C. §§ 120 and 365 of PCT Application No. PCT/AU03/00460, filed on Apr. 16, 2003 and published Oct. 30, 2003, in English, which is hereby incorporated by reference.

### BACKGROUND OF INVENTION

1. Field of the Invention

The present invention relates to a hierarchical system for analyzing data streams. In particular, the present invention relates to analyzing data streams to identify target events. A target event may be an instance of fraud on a telephone system, however the present invention has applications in other high data volume environments to identify other target events/activities.

2. Description of the Related Technology

Fraud is a serious problem in modern telecommunication systems, and can result in revenue loss by the telecommunications service provider, reduced operational efficiency, and an increased risk of subscribers moving to other providers that are perceived to offer better security. In the highly competitive telecommunications sector, any provider that can reduce revenue loss resulting from fraud—either by its prevention or early detection—has a significant advantage over its competitors.

Telecommunications networks support many hundreds or thousands of transactions per second, and one of the challenges in developing effective fraud detection systems is to achieve the high throughput necessary to analyze all network traffic in detail and in real time. In practice, fraud detection systems frequently ignore services that are considered to be low risk (e.g. low cost calls), or limit the sophistication of the fraud detection algorithms in order to achieve the required throughput.

Each of these has critical disadvantages—ignoring services automatically precludes the detection of fraud on those services—which is particularly hazardous because fraudsters actively search for unprotected services. Similarly, the use of fast but inaccurate algorithms increases the range of frauds that cannot be detected without increasing the number of false alerts. Telecommunications service providers are therefore often forced to accept higher false alert rates in order to maintain sensitivity at high throughput, and hence incur additional costs resulting from an enlarged fraud investigation team that is required to process the extra alerts.

### SUMMARY OF CERTAIN INVENTIVE ASPECTS OF THE INVENTION

One aspect of the invention provides a system of hierarchical data analysis that seeks to provide high throughput and sensitivity with less false positive alerts of possible target activity.

Another aspect of the invention provides a method for analyzing data streams comprising: receiving a data stream; conducting a first analysis of the data stream for a possible target activity, and if a possible target activity is indicated generating a first alert; if the first alert is generated, conducting a second analysis for the possible target activity to determine whether the target activity is indicated in the data stream with a high degree of certainty, if a possible target activity is indicated by the second analysis, generating a second alert; and providing the second alert to an external system for action.

Preferably the first analysis comprises: conducing a first sub-analysis of the data stream for the possible target activity to determine whether the target activity is indicated in the data stream, if the possible target activity is indicated by the first sub-analysis then a first sub-alert is generated; and conducting a second sub-analysis of the data stream for the possible target activity to determine whether the target activity is indicated in the data stream with a higher degree of certainty than in the first sub-analysis, if the possible target activity is indicated by the second sub-analysis then the first alert is generated.

Preferably the second sub-analysis provides an indication of the target activity with a higher degree of certainty than in the first sub-analysis. Preferably the second analysis provides an indication of the target activity with a higher degree of certainty than in the second sub-analysis.

Preferably the method further comprises propagating data from the data stream relevant to the second sub-analysis for conducting the second sub-analysis. Preferably the method further comprises propagating data from the data stream relevant to the second analysis for conducting the second analysis.

Preferably the second sub-analysis is conducted on additional data to the propagated data. Preferably the second analysis is conducted using additional data to the data propagated for the second analysis.

Preferably one or more additional levels of sub-analysis are conducted between the first sub-analysis and the second sub-analysis wherein an alert is generated by one of the additional levels and passed to a next of the additional levels. Preferably a subsequent analysis is conducted while determining whether the target activity is indicated to a higher degree of certainty than the previous level. Preferably the first sub-alert triggers the first of one or more additional levels of sub-analysis and the alert generated by the final level of additional sub-analysis triggers the second sub-analysis.

Preferably data is propagated from one additional level of sub-analysis to the next and includes data necessary in the subsequent levels of additional sub-analysis.

Preferably each additional level of sub-analysis is conducted on additional data specific to the type of analysis conducted in addition to the propagated data.

Preferably each level of the sub-analysis creates a third alert if a fraudulent activity is indicated with a relatively high degree of certainty, any one of the second alerts and third alerts triggering an action in the external system.

Preferably the first analysis may conduct one or more types of analysis in parallel.

Preferably one or more of the additional levels of sub-analysis may conduct one or more types of analysis in parallel.

Preferably the target activity is fraudulent activity.

Another aspect of the invention provides a system for analyzing data streams comprising: a first analyzer arranged to analyze a data stream for possible target activity and if a possible target activity is indicated to generate a first alert; a second analyzer arranged to conduct an analysis for possible target activity if the first alert is generated, and if a possible target activity is indicated with a relatively high probability by the second analysis to generate a second alert for an external system to act on.

Still another aspect of the invention provides a system for analyzing data streams comprising: one or more sequential analyzers are arranged to conduct an analysis for possible target activity, a first analyzer of the sequence of analyzers analyzing a data stream, each subsequent analyzer of the sequence of analyzers only conducting its analysis if the previous analyzer indicates a possible target activity, and if a possible target activity is indicated by each analysis generating a subsequent alert for the next analyzer; and a final analyzer arranged to conduct an analysis for possible target activity if the last analyzer of the sequence of analyzers generates an alert, and if a possible target activity is indicated with a relatively high probability by the analysis of the final analyzer, the final analyzer generates an alert for an external system to act on.

Still another aspect of the invention provides a method of analyzing data streams comprising: conducing one or more sequential analyzers of a data stream for possible target activity, the first of the analyzers being conducted directly on the data stream, subsequent analysis after the first, only being conducted if the previous analysis indicated a possible target activity; conducting a final analysis for possible target activity if the last of the sequential analyzers indicate a possible target activity; and if the final analysis indicates a possible target activity with a relatively high degree of certainty generating an alert to an external system for action.

### BRIEF DESCRIPTION OF THE DRAWINGS

In order to facilitate a better understanding of the nature of the invention, preferred embodiments will now be described in greater detail, by way of example only, with reference to the accompanying drawings in which:

FIG. 1 is a schematic representation of a preferred embodiment of a system for analyzing data streams in accordance with one embodiment of the invention; and

FIG. 2 is a schematic representation exemplifying data analysis using the system of FIG. 1.

### DETAILED DESCRIPTION OF CERTAIN EMBODIMENTS OF THE INVENTION

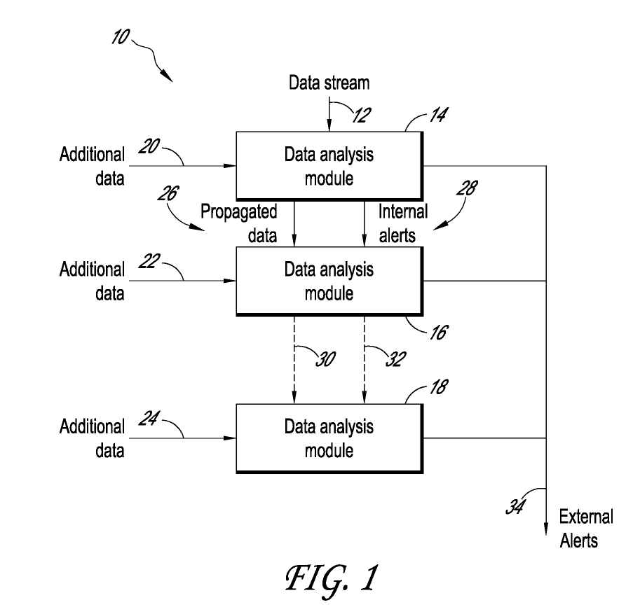

Referring to FIG. 1 there is shown a system 10 that receives a data stream 12 (that may include one or more sub-streams) and outputs a data stream of alerts 34 for use by an external system. The system 10 includes a plurality of data analysis modules, in this case three are shown 14, 16 and 18. Each of the analysis modules 14, 16 and 18 receives respective additional data 20, 22 and 24 used in the analysis of the data stream 12 provided to the first data module 14. Each data module 14, 16 and 18 propagates data to the next data module indicated by propagated data 26 and 30. Each data module provides internal alerts 28 and 32 to the subsequent data module.

In the present example the system 10 is configured to identify suspicious telephone activity that may indicate fraud. Due to the high volume of telephone call data required to be processed, each data analysis module can provide a different analysis technique to progressively increase the certainty that the data indicated the presence of fraudulent telephone activity.

The system 10 may be implemented in the form of a computer or a network of computers programmed to perform the analysis of each of the modules. For example, a single computer can be programmed to run the system or a dedicated computer may be programmed to conduct each of the analysis of each of the modules with communication being provided between each of the computers of the whole system 10.

Each of the data analysis modules 14, 16 and 18 cascade data initially provided by data stream 12 to the subsequent module. The data stream 12 could, for example, include call data records (CDRs, which contain details of the calls made on a telecommunication network). For example, a portion of a CDR produced from a real call is given in Table 1. The fields contained in the CDR are (from top to bottom) A-number (the number of the phone from which the call was made), B-number (the number to which the call was made), B-number type (whether it was local, national, international etc encoded as a number), the call's cost, its duration and the date and time at which it started. Note that the four rightmost digits of the A- and B-numbers have been masked to conceal the identities of call to call parties. The data stream 12 can also include several substreams from different sources. For example, one substream could be a CDR stream, while another could provide customer information such as postcodes and payment histories.

TABLE 1

| CDR Field | Value |
|---|---|
| A_NO | 11484XXXX |
| B_NO | 11789XXXX |
| B_TY | 2 |
| CCU | 1 |
| CD | 92 |
| Sdate | 05/05/98 |
| STime | 11:13:28 |

Each of the data analysis modules 14, 16 and 18 contains one or more fraud detection engines that analyze their input data for signs of fraudulent activity, in response to which they generate alerts. Each fraud detection engine can process different subsets of the modules' input data. Each data analysis module after the first, receives propagated data that is passed from the analysis module immediately receiving it in the hierarchy. The additional data available to each data analysis module may be specific to the type of analysis conducted by that particular data analysis module. The propagated data may contain low level data from the original data stream 12 or additional data used by data analysis modules lower in the hierarchy, depending on the configuration of the system 10.

The distinction between propagated data and additional data is important for the efficiency of the system because the analysis performed within particular analysis modules may require particular access to potentially large quantities of data that are not required elsewhere within the system. Propagating data that is not required in other analysis modules is a waste of resources and is likely to reduce the rate at which the system can process incoming data. Propagated data consists of information that is used in more that one data analysis module. For example, the A-number field is used to identify the calling party, is provided within the CDR stream that usually forms part of the systems input 12, and is usually required throughout the system, and hence usually propagated through the system rather than forming part of the additional data inputs.

Each of the data analysis modules 14, 16 and 18 can generate internal and external alerts. External alerts 34 are combined from all of the modules 14, 16 and 18 to form the output 34 of the system. Combining the outputs may be the equivalent of providing a logical OR to each of the alerts, so that if any of the modules generates an external alert, the system as a whole generates the alert. External alerts are only produced by the modules when the calculated probability of a target activity (fraud) is sufficiently high to reasonably conclude that fraud has occurred. What is considered a high probability depends on the particular application, its expected throughput, and the desired degree of certainty. When individual calls are analyzed for fraud within telecommunication networks, a probability as large as 0.99995 to 0.99999 may be required to keep the number of alerts to a manageable level (since large networks can experience as many as 100 million calls per day).

Each of the data analysis modules 14, 16 and 18 can generate internal alerts if its analysis reveals something unusual, but does not provide sufficiently high probability that target activity is indicated to warrant an external alert. Internal alerts are important for regulating the activity of subsequent data analysis modules within the hierarchy of the system, because subsequent data analysis modules may only be activated if an internal alert is received, indicating that further analysis of the data is required to obtain the sufficient degree of certainty to generate an external alert. Subsequent data analysis modules 16 and 18 may only be activated if they receive an internal alert 28 or 32 from a proceeding analysis module or if any of its input data is updated. Preferably the additional data is only provided in response to a request made by a lower module and the input additional data is not configured to activate an analysis module.

For example, an analysis module 14, 16 or 18 may identify a short term increase in the total cost of calls made by a particular subscriber, which may not be severe enough to conclude that fraud has occurred and hence to generate an external alert. A subsystem may therefore generate an internal alert that causes the next module in the system to perform its analysis. This cascaded activation of analysis modules within the system means that lower level subsystems are activated most frequently and that the throughput of the system can be maximised by designing the lower level subsystems to require a minimum amount of processing. Higher level analysis, which is activated less frequently can thus use more expensive processes (such as nonlinear or iterative functions) and can perform expensive operations (such as database reads and writes) or make use of human intervention, with minimal effect on the throughput of the entire system. For example, a neural network could be trained to estimate the probability that a particular telephone call was fraudulent based on its characteristics (cost, duration, etc.) or Fourier analysis could be used to see if a short term fluctuation in the calling activity was part of a cycle of a subscriber's normal behaviour in an analysis module that becomes active only once a lower level system has generated an alert.

Dividing the system into a series of stages of increasing complexity of different (and in particular, increasing) complexity, also simplifies the problem of targeting different resources at different subsystems. For example, the lower level subsystems may need some level of parallelism in order to achieve the required throughput and thus can be distributed across several computers. Later stages may require so little resources that several can be run simultaneously on a single computer while others may require user interaction or database access, placing specific requirements on their geographic location. By building a fraud detection system from a hierarchy of subsystems of increasing sophistication it is possible to produce a superior trade off between fraud detection accuracy and throughput.

Each of the data analysis modules should be designed to generate many more internal false positives (that is, internal alerts for events that are not actually fraudulent) than internal false negatives (where an internal alert was not generated when fraud did in fact occur). This is because the higher level subsystems that are activated by the internal alerts may be able to provide a higher degree of certainty to confirm or refute the internal alert based on different analysis techniques and/or the inclusion of additional data in the analysis to clarify whether, with the required of certainty, the data indicates that a fraud is actually present. If the system is not designed in this way, then when false negatives occur the higher level subsystems are never activated and thus are not able to correct an error made by the lower level subsystem.

Conversely, the analysis modules 14, 16 and 18 are designed to generate a small number of external false positives (external alerts generated for events that are not actually fraudulent) and a large number of external false negatives (resulting in no external alert being generated when in fact a fraud did occur). This is because provided that an internal alert was generated, the external false negative can be corrected by higher level analysis modules generating their own external alerts. In a situation where a false positive external alert is generated the system as a whole will generate an alert that can't be prevented by analysis conducted at a subsequent level modules even if subsequent modules were activated.

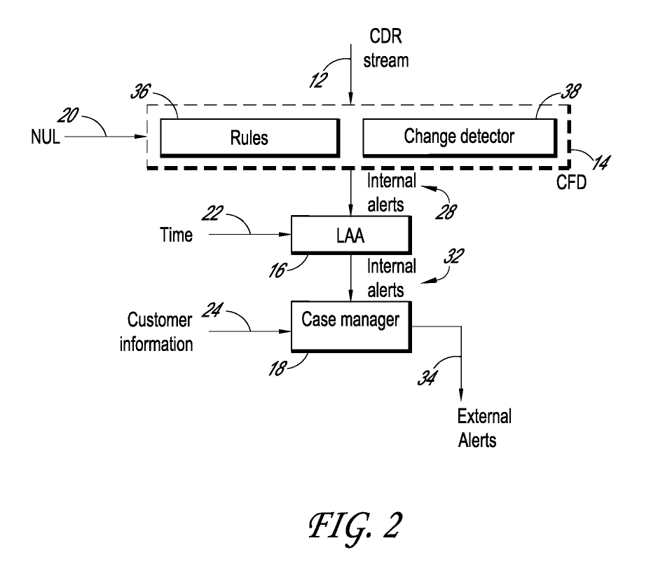

FIG. 2 shows an example of a real telecommunications fraud detection system based on the system 10. The input data stream 12 includes a CDR stream that provides details of each call made on the telecommunications network shortly after the call is terminated. The CDR stream is passed to the lowest level data analysis module 14 which is configured as a candidate fraud detector (CFD). The CFD contains two separate fraud detection algorithms, based on a set of rules 36 that search directly for common fraud indicators (such as more than 8 hours of calls to the Caribbean in any 24 hour period), and change detection algorithm 38 that searches for unusual changes in the pattern of behaviour associated with individual subscribers (which can indicate that a line has been taken over by fraudsters). These two components 36 and 38 of the lowest level data analysis module 14 operate independently. An internal alert 28 is generated when either of its components 36 and 38 indicates that a particular telephone call is a fraud candidate. The rules 36 and change detector 38 are designed to be fast and simple because the CDR stream 12 can present the data analysis module with as many as 100 million CDRs per day. The internal alerts 28 are passed to the next level data analysis module which operates as an intelligent alarm analyzer (IAA) which is only activated when an internal alert is generated by the CFD.

With a typical fraud detection configuration, the ratio of the number of CDRs to the number of internal alerts 28 is about 1000:1 meaning that statistically the IAA is activated only once for every 1000 times the CFD is activated. The IAA is a rule based system that removes some of the false alerts generated by the CFD by performing complex analysis on the distributions of the alerts themselves. These complex analyzers are possible due to the low level of activity demanded of the IAA compared to the CFD. The analyzers also require time information (real world, date and time) which is provided to the IAA as additional data 22. When the IAA considers the distribution of alerts to be sufficiently suspicious, it generates an internal alert 32 which is passed to the next level data analysis module 18. The ratio of the numbers of alerts generated by the CFD compared to those generated by the IAA is usually around 500:1, meaning that statistically the third level of data analysis is activated once every 500 times the IAA is activated.

The third level data analysis module operates as a case manager. The case manager may be a team committed by the telecommunications operator employed for the purpose of investigating the events that caused internal alerts to be generated by the IAA. Because the case manager is a higher level subsystem it is activated only once every 500,000 or so CDRs and hence can use much slower and more expensive processing methods such as manual, investigations of potential frauds than either the CFD or IAA without being overwhelmed.

The case manager uses customer information (names, addresses, payment histories, etc.) as further additional data 24 and frequently a wide variety of additional data sources (six month history of calls made by a particular customer) to investigate internal alerts 32 generated by the IAA to determine whether they are likely to be cases of actual fraud. If it is determined that they are, the case manager subsystem generates an external alert 34 which is passed out of the system. The alert could be used for a variety of purposes, such as to inform billing services within the network operator to remove fraudulent calls from a customer's bill, or to inform law enforcement agencies.

In this example, neither the CFD nor the IAA generate external alerts because of the technical difficulties in guaranteeing extremely low false alert rates that are required for the purposes for which the external alerts are intended. However it will be appreciated that in other configurations, these modules may be suited to generating external alerts. It is also noted that in this example, null additional data 20 is provided to the CFD. Furthermore, it is also noted that no data is propagated from the CFD to the IAA or from the IAA to the case manager. It is further noted that in an alternative configuration, additional data may be provided to the CFD or data may be propagated from the CFD to the IAA and possibly then from the IAA to the case manager.

It will be appreciated by the person skilled in the art that the hierarchical system and method of the present invention may be applied to data streams that originate from a variety of sources to identify target events. The above example of fraud detection on a telecommunications network is not intended to be limiting.

It will be appreciated that modifications may be made to the preferred forms of the present invention without departing from the basic inventive concept. Such modifications are intended to fall within the scope of the present invention, the nature of which is to be determined from the foregoing description and appended claims.

1. A method for analyzing data streams, comprising:
receiving a data stream;
conducting a first analysis of the data stream for an indication of the target activity, where it can not be determined with certainty that the target activity is present, and generating a first alert in the event that the target activity is potentially indicated;
in the event that the first alert is generated, conducting a second analysis for an indication of the target activity to determine whether the target activity is indicated in the data stream with a high degree of certainty, and generating a second alert in the event that the target activity is potentially indicated by the second analysis.

2. A method according to claim 1, wherein the first analysis comprises:
conducing a first sub-analysis of the data stream for an indication of the target activity in the data stream, and generating a first sub-alert in the event that the target activity is potentially indicated; and
in the event that the first sub-alert is generated, conducting a second sub-analysis of the data stream for an indication of the target activity in the data stream with a higher degree of certainty than in the first sub-analysis, and generating the first alert in the even that the target activity is potentially indicated by the second sub-analysis.

3. A method according to claim 1, wherein the second analysis provides an indication of the target activity with a higher degree of certainty than in the first analysis.

4. A method according to claim 3, wherein the second analysis provides an indication of the target activity with a higher degree of certainty than in the second sub-analysis.

5. A method according to claim 2, further comprising propagating data from the data stream relevant to the second sub-analysis for conducting the second sub-analysis.

6. A method according to claim 2, further comprising propagating data from the data stream relevant to the second analysis for conducting the second analysis.

7. A method according to claim 2, wherein the second sub-analysis is conducted on additional data to the propagated data.

8. A method according to claim 7, wherein the second analysis is conducted using additional data to the data propagated for the second analysis.

9. A method according to claim 2, wherein one or more additional levels of sub-analysis are conducted between the first sub-analysis and the second sub-analysis wherein an alert is generated by one of the additional levels and passed to a next of the additional levels.

10. A method according to claim 9, wherein a subsequent analysis is conducted while determining whether the target activity is indicated to a higher degree of certainty than the previous level.

11. A method according to claim 10, wherein the first sub-alert triggers the first of one or more additional levels of sub-analysis and the alert generated by the final level of additional sub-analysis triggers the second sub-analysis.

12. A method according to claim 11, wherein data is propagated from one additional level of sub-analysis to the next and includes data necessary in the subsequent levels of additional sub-analysis.

13. A method according to claim 12, wherein each additional level of sub-analysis is conducted on additional data specific to the type of analysis conducted in addition to the propagated data.

14. A method according to claim 13, wherein each level of the sub-analysis creates a third alert if a fraudulent activity is indicated with a relatively high degree of certainty, any one of the second alerts and third alerts triggering an action in an external system.

15. A method according to claim 1, wherein the first analysis may conduct one or more types of analysis in parallel.

16. A method according to claim 2, wherein one or more of the additional levels of sub-analysis may conduct one or more types of analysis in parallel.

17. A system for analyzing data streams, comprising:
a first analyzer arranged to analyze a data stream for an indication of a target activity, where it is not necessarily certain that the target activity is present, wherein the first analyzer generates a first alert signal in the event that the target activity is potentially indicated; and
a second analyzer arranged to conduct an analysis for an indication of the target activity upon generation of the first alert signal, wherein the second analyzer generates a second alert signal in the event that the target activity is potentially indicated with a relatively high probability.

18. A system for analyzing data streams, comprising:
one or more sequential analyzers arranged to conduct an analysis for a target activity, where it is not necessarily certain that the target activity is present, a first analyzer of the sequence of analyzers analyzing a data stream for an indication of the target activity, each subsequent analyzer of the sequence of analyzers only conducting its analysis if the previous analyzer indicates a possibility of the target activity being present, and if the target activity is potentially indicated by each analysis generating a subsequent alert for the next analyzer; and
a final analyzer arranged to conduct an analysis for an indication of the target activity in the event that the last analyzer of the sequence of analyzers generates an alert and if the target activity is indicated with a relatively high probability by the analysis of the final analyzer, the final analyzer is arranged to generate an alert for an external system to act on.

19. A method for analyzing data streams, comprising:
conducing one or more sequential analyzers of a data stream for a target activity, where it is not necessarily certain that the target activity is present, the first of the analyzers being conducted directly on the data stream for an indication of the target activity, subsequent analysis after the first, only being conducted if the previous analysis indicated a possibility of the target activity being present;
in the event that the last of the sequential analyzers indicates the target activity is potentially present conducting a final analysis for an indication of the target activity; and
in the event that the final analysis indicates the target activity is likely to be present with a relatively high degree of certainty, then generating an alert for action.

20. A method according to claim 1, wherein more than one target activity is sought, where it is not necessarily certain that each of the target activities is present.

21. A system for analyzing data streams, comprising:
means for receiving a data stream;
means for conducting a first analysis of the data stream for an indication of the target activity, where it can not be determined with certainty that the target activity is present, and generating a first alert in the event that the target activity is potentially indicated;
means for in the event that the first alert is generated, conducting a second analysis for an indication of the target activity to determine whether the target activity is indicated in the data stream with a high degree of certainty, and generating a second alert in the event that the target activity is potentially indicated by the second analysis.
